(19) United States
(12) Patent Application Publication
(10) Pub. No.: US 2007/0017389 A1
(43) Pub. Date: Jan. 25, 2007

(54) Chafing dish system

(75) Inventor: Sol Basch, Brooklyn, NY (US)

Correspondence Address: OSTROLENK FABER GERB & SOFFEN, 1180 AVENUE OF THE AMERICAS, NEW YORK, NY, 100368403, US

(73) Assignee: Eastern Tabletop Manufacturing Company, Inc.

(21) Appl. No.: 11/188,917

(22) Filed: Jul. 25, 2005

(51) Int. Cl. A23C 15/04

(52) U.S. Cl. 99/483

(57) ABSTRACT

A chafing dish system having at least one chafing dish with at least one leg with a top end and a bottom end, the top end of the leg having an upwardly projecting formation, and the bottom end of the leg being configured to fit over the upwardly projecting formation of another leg. When two chafing dishes are used, at least one leg of one of the chafing dishes is engageable with the upwardly projecting formation of one leg of another of the chafing dishes.

### BACKGROUND OF THE INVENTION

The present invention relates to chafing dishes, and more particularly to a system of interconnectable chafing dishes.

Chafing dishes have long been used in the catering business for serving and presenting food. Although conventional chafing dishes are suitable for serving food and have been in use for a number of years, they have the drawback of being difficult to store when not in use. Furthermore, conventional chafing dishes are difficult to arrange in an appealing fashion on a buffet table due to the chafing dishes needing to be individually placed.

### SUMMARY OF THE INVENTION

Accordingly, it is an object of the present invention to provide a chafing dish system which allows chafing dishes to be easily stacked and also allows the chafing dishes to be interconnected into various configurations that are visually appealing as well as efficient for users.

Pursuant to this object, the inventive chafing dish system includes at least one chafing dish having at least one leg with a top and a bottom end. The top end of the leg is configured to have an upwardly projecting formation and the bottom end of the leg is configured to fit over the upwardly projecting formation of another leg.

The upwardly projecting formation can generally be any desired geometric shape, such as a circle, a square, a triangle, etc. In a preferred embodiment, the formation is circular.

When additional chafing dishes are added to the chafing dish system, the bottom ends of the legs of the additional chafing dish can fit over the upwardly projecting formation on the top end of the legs of the first chafing dish so that the chafing dishes can be at different levels.

In another embodiment of the invention, leg extensions are provided which have a top end with the upwardly projecting formation and a bottom end configured to fit over the upwardly projecting formation of another leg or leg extension. In this way, it is possible to elevate a chafing dish by simply attaching leg extensions to the existing legs of the chafing dish.

Of course, the chafing dish can be equipped with any one of a number of conventional components such as a cover, a carving board, etc.

Other features and advantages of the present invention will become apparent from the following description of the invention that refers to the accompanying drawings.

### BRIEF DESCRIPTION OF THE DRAWINGS

FIG. 1 is a perspective view of a chafing dish of the present invention;

FIG. 2 is a schematic view showing an arrangement of several chafing dishes of the chafing dish system;

FIG. 3 shows another arrangement of chafing dishes; and

FIG. 4 shows chafing dishes stacked for storage.

### DETAILED DESCRIPTION OF EMBODIMENTS OF THE INVENTION

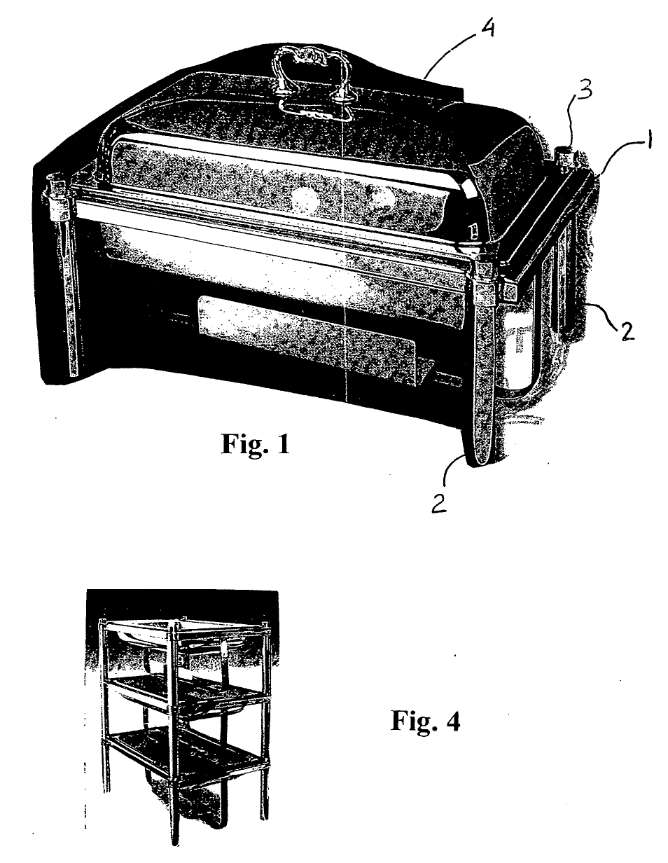

FIG. 1 shows one embodiment of a chafing dish 1 for the inventive chafing dish system. The chafing dish has legs 2 that are provided with an upwardly projecting formation 3 at their upper end. The bottom end of each leg 2 is configured so as to be engageable over the upwardly projecting formation 3 of another leg. In the illustrated embodiment the upwardly projecting formation 3 is circular, as is the cross-section of the leg 2 itself. However, the upwardly projecting formation and the cross-section of the leg can have any desired shape, for example a rectangle or a triangle. All that is necessary is that the bottom of the leg be engageable with the upwardly projecting formation of another leg.

The chafing dish 1 shown in FIG. 1 also has a cover 4 which is removably placed on the chafing dish 1.

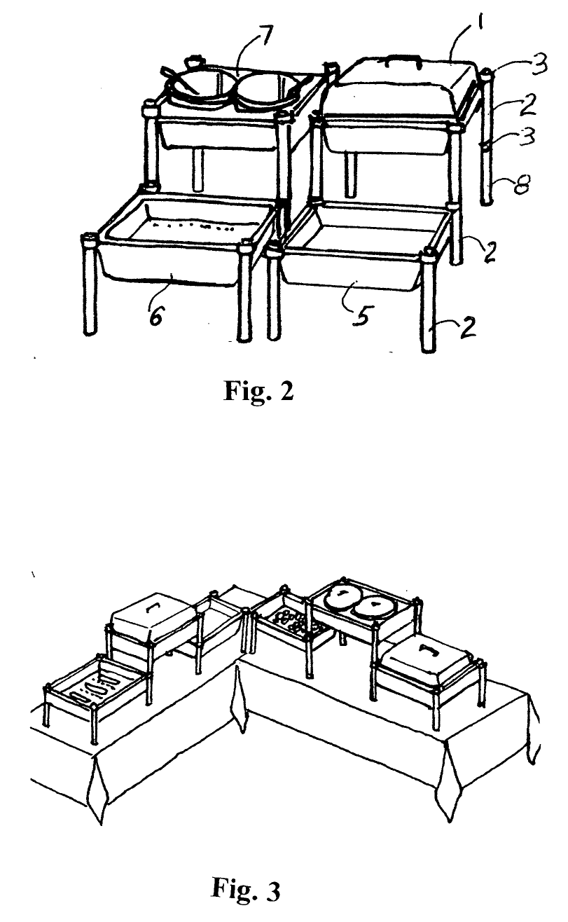

FIG. 2 shows an arrangement of four chafing dishes 1, 5, 6, 7. Each of the chafing dishes has four legs 2. The front legs of the chafing dishes 1, 7 engage over the upwardly projecting formations 3 of the rear legs of the chafing dishes 5, 6. In order for the chafing dishes 1, 7 to be level, leg extensions 8 are attached to the rear legs 2 of the chafing dishes. The leg extensions 8 have an upwardly projecting formation 3 that engages with the bottom end of the leg 2.

FIG. 3 shows yet another arrangement of multiple chafing dishes. The inventive chafing dish system allows the chafing dishes to be aligned in virtually any vertical, horizontal, curved, squared or rounded arrangement.

This unique system allows the chafing dishes to be arranged on multiple levels without the need for boxes or risers which were necessary in the prior art.

Furthermore, although a rectangular chafing dish is illustrated, it is also possible for the chafing dish to have other shapes, for example, circular or triangular. Various shapes of chafing dishes can be intermingled in any desired fashion to provide a unique buffet arrangement. Also, although the illustrated embodiments show chafing dishes with four legs, it is understood that the chafing dishes can have fewer or more legs, as desired and necessary for stability.

FIG. 4 shows a number of chafing dishes stacked on top of one another for storage via the inter-engaging upper and lower ends of the legs.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A chafing dish system having at least one chafing dish having at least one leg with a top end and a bottom end, the top end of the leg having an upwardly projecting formation, and the bottom end of the leg being configured to fit over the upwardly projecting formation of another leg.

2. The chafing dish system as defined in claim 1, wherein two chafing dishes are provided, at least one leg of one of the chafing dishes being engageable with the upwardly projecting formation of one leg of another of the chafing dishes.

3. A chafing dish system according to claim 2, wherein the legs have a circular cross-section and the upwardly projecting formation is circular.

4. The chafing dish system according to claim 2, wherein each chafing dish has four legs.

5. The chafing dish system according to claim 2, wherein the chafing dishes are rectangular.

6. The chafing dish system according to claim 1, and further comprising leg extensions, each leg extension having an upper end with an upwardly projecting formation and a bottom end configured to fit over the upwardly projecting formation of another of the legs.
